(19) United States
(12) Patent Application Publication
(10) Pub. No.: US 2004/0202095 A1
(43) Pub. Date: Oct. 14, 2004

(54) Spindle motor and mobile communication system using the same

(76) Inventor: Seong Ho Shin, Kyungki-do (KR)

Correspondence Address: LOWE HAUPTMAN GILMAN & BERNER, LLP, Suite 310, 1700 Diagonal Road, Alexandria, VA, 22314, US

(21) Appl. No.: 10/749,587

(22) Filed: Jan. 2, 2004

(30) Foreign Application Priority Data
Apr. 8, 2003 (KR) 2003-22070
Sep. 1, 2003 (KR) 2003-60882

(51) Int. Cl. G11B 17/04

(52) U.S. Cl. 369/264; 369/208

(57) ABSTRACT

Disclosed is a spindle motor in use for a disk drive and a mobile communication system using the same. The spindle motor comprises a circuit board, a cylindrical housing fixedly mounted on the circuit board and allowing a shaft to be rotatably inserted into the housing, a plurality of grooves formed in an inner periphery of the housing, and a molybdenum disulfide film formed through penetration in the inner periphery of the housing including the grooves. The molybdenum disulfide film and the grooves serve as lubricant to the shaft during rotation of the shaft. An armature is arranged on the circuit board adjacent to an outer periphery of the housing and having lamellar conductors laminated one atop another. A rotor is integrally fixed to the shaft, and has a turntable arranged in a top portion thereof for seating a disk and a magnet arranged in an underside portion thereof for cooperating with the armature to generate electromagnetic force to turn the rotor.

### BACKGROUND OF THE INVENTION

### CROSS-REFERENCE TO RELATED APPLICATION

This application claims to benefit of Korean Patent Application NO. 2003-022070 filed Apr. 8, 2003 and NO. 2003-060882 filed Sep. 1, 2003, in the Korean Intellectual Property Office, the disclosure of which is incorporated herein by reference.

### FIELD OF THE INVENTION

The present invention relates to a spindle motor in use for a disk drive and a mobile communication system using the same.

### DESCRIPTION OF THE RELATED ART

In general, personal mobile communication systems include a mobile phone, a Personal Digital Assistant (PDA), a pager, a radio telephone, a notebook computer having a mobile communication function and so on.

Due to its popularity, the mobile phone is regarded as the most representative example of the mobile communication systems. Beginning from a simple device which provides a user with a speech function, the mobile phone has been developed into a personal telecommunication system which stores telephone numbers and various data, and links with the Internet, and functions as a camera or camcorder. Currently, the mobile phone even plays multimedia images.

The mobile phone has been developed into the personal telecommunication system through expansion of its memory. An example of memory expansion technologies is disclosed in Korean Patent Publication Serial No. 2002-4620 entitled “Mobile Terminal Using Detachable Memory Card”, filed prior to this application. According to this document, a detachable memory card can be loaded into a mobile phone to further expand the storage capacity of the mobile phone.

The following will describe Korean Patent Publication Serial No. 2002-4620 with reference to FIG. 1 which is a conceptual view of a conventional personal mobile communication system.

As shown in FIG. 1, a mobile phone 1 as the conventional communication system comprises a memory card 2 which is detachably loaded into the mobile phone 1 to enlarge the storage capacity of the mobile phone 1. The memory card 2 allows the mobile phone 1 to share data with various devices such as a computer 11, a printer 12 and a digital camera 13.

That is, as the memory card 2 expands the memory capacity of the mobile phone 1 to store a large quantity of data so that the computer 11 can edit the stored data or the printer 12 can print the stored/edited data.

However, since the memory card 2 has a data storage capacity which is remarkably smaller than that of a typical CD or a hard disk, the memory card 2 can expand the data storage capacity of the mobile phone 1 by a limited degree even though the memory card 2 is upgraded.

Although data compression techniques such as MP3 are used in order to overcome the limitation of the memory card 2, the data storage capacity of the memory card 2 is still remarkably small compared with that of the CD or the hard disk.

Further, the memory card 2 itself cannot store all types of data having a large capacity such as dynamic and still images.

Furthermore, the memory card 2 is expensive compared with the DC or the hard disk disadvantageously raising the unit price of the mobile phone 1 having the memory card 2 so that the mobile phone 1 becomes unpopular with consumers.

However, the CD or the hard disk is not applied to the mobile phone 1 in spite of the above problems of the memory card 2 since a disk drive for rotating the CD or the hard disk has a remarkably large size in comparison with that of the mobile phone 1.

The disk drive cannot be reduced in size without reduction in the size of a spindle motor, i.e., a core component of the disk drive. However, the size of spindle motors developed up to the present is not applicable to the mobile phone 1.

While the data storage capacity of the CD or the hard disk loaded into the disk drive is currently increased up to tens of giga bites (GB), the size of the CD or the hard disk is getting gradually reduced, in particular, to the size of a coin. It is also expected that the size of the CD or the hard disk will be further reduced sooner or later.

Therefore, even though the size of the CD or the hard disk is reduced, the size of the spindle motor is not applicable to the mobile phone 1 and thus the CD or the hard disk cannot be applied to the mobile phone 1.

The afore-mentioned spindle motor will be hereinafter described in more detail with reference to FIG. 2. FIG. 2 is a sectional view of a conventional spindle motor for disk drives. As shown in FIG. 2, the spindle motor comprises a deck plate DP, a stator 20 fixedly mounted on the deck plate DP, a rotatable shaft S arranged perpendicular to the stator 20 and a rotor 30 mounted on the shaft S and rotating together with the shaft S.

Describing components of the spindle motor in more detail, the stator 20 includes a core 22 having coils wound thereon, a holder 24 for fixing the core 24 and a cylindrical metal bearing 24a arranged in the inner periphery of the holder 24.

The shaft S is arranged rotatable in the inner periphery of the metal bearing 24a, and a washer type thrust bearing 24b is arranged under the shaft S to prevent friction between the shaft S and the deck plate DP.

The rotor 30 in the form of a cap is fixedly arranged around a top portion of the shaft S with a predetermined gap from the stator 20. A permanent magnet 32a is arranged in the lower periphery of the rotor 30 in order to generate magnetic force which interacts with the electromagnetic force created from the core 22 of the stator 20 to turn the rotor 30.

The rotor 30 includes a turntable 32 having a disk chuck 34 for fixedly seating a data-stored disk D on an upper face of the turntable 32.

Therefore, when the disk D is seated on the turntable 32 of the spindle motor, the rotor 30 interacts with the stator 20 to rotate about the shaft S thereby turning the disk D at a high speed.

However, the spindle motor of the above construction is hardly reduced in size since the components of the spindle motor maintain their predetermined sizes. In particular, the core 22 and the magnet 32a are required to maintain predetermined sizes to generate a sufficient amount of magnetic force for imparting high speed rotation to the spindle motor.

### SUMMARY OF THE INVENTION

The present invention has been made to solve the foregoing problems and it is therefore an object of the present invention to miniaturize a spindle motor by realizing both a coil and a magnet of the spindle motor in the form of thin films thereby reducing the size of a disk drive so that the disk drive can be applied to a mobile phone or a mobile communication system.

It is another object of the invention to apply a disk drive incorporating the spindle motor of the invention to a mobile phone or a personal mobile communication system in order to expand the data storage capacity of the mobile phone.

According to an aspect of the invention for realizing the object, there is provided a spindle motor for disk drives comprising: a circuit board; a cylindrical housing fixedly mounted on the circuit board and allowing a shaft to be rotatably inserted into the housing; a plurality of grooves formed in an inner periphery of the housing; a molybdenum disulfide film formed through penetration in the inner periphery of the housing including the grooves, the molybdenum disulfide film and the grooves serving as lubricant to the shaft during rotation of the shaft; an armature arranged on the circuit board adjacent to an outer periphery of the housing and having lamellar conductors laminated one atop another; and a rotor integrally fixed to the shaft and having a turntable arranged in a top portion thereof for seating a disk and a magnet arranged in an underside portion thereof for cooperating with the armature to generate electromagnetic force to turn the rotor.

It is preferred that the grooves are formed radially in the inner periphery of the housing at a uniform spacing in an axial direction.

It is also preferred that the grooves are formed in the inner periphery of the housing by spraying fluid under high pressure, the fluid being made of a material same as that of the molybdenum disulfide film.

It is preferred that the magnet of the rotor is formed by printing magnet powder on the underside portion of the rotor.

It is preferred that the magnet of the rotor is formed by depositing magnetic powder on the underside portion of the rotor.

It is also preferred that the magnetic powder has a particle size ranging about 500 to 1000 nm so that a large number of powder particles cohere at the underside portion of the rotor to enhance magnetic force.

According to another aspect of the invention for realizing the object, there is provided a spindle motor for disk drives comprising: a circuit board; a cylindrical housing fixedly mounted on the circuit board; a shaft rotatably inserted into the housing; a plurality of grooves formed in an inner periphery of the housing; a molybdenum disulfide film formed through penetration in the inner periphery of the housing including the grooves, the molybdenum disulfide film and the grooves serving as lubricant to the shaft during rotation of the shaft; an armature arranged on the circuit board adjacent to an outer periphery of the housing and having lamellar conductors laminated one atop another; and a rotor integrally fixed to the shaft and having a turntable arranged in a top portion thereof for seating a disk and a magnet arranged in an underside portion thereof for cooperating with the armature to generate electromagnetic force to turn the rotor.

According to further another aspect of the invention for realizing the object, there is provided a personal mobile communication system comprising: a main body having a data input unit, a main body circuit board and a liquid crystal display; and a disk drive having a spindle motor mounted inside the main body for rotating a data storage disk, wherein the spindle motor includes: a spindle motor circuit board selectively connected with the main body circuit board; a cylindrical housing fixedly mounted on the spindle motor circuit board and allowing a shaft to be rotatably inserted into the housing; a plurality of grooves formed in an inner periphery of the housing; a molybdenum disulfide film formed through penetration in the inner periphery of the housing including the grooves, the molybdenum disulfide film and the grooves serving as lubricant to the shaft during rotation of the shaft; an armature arranged on the spindle motor circuit board adjacent to an outer periphery of the housing and having lamellar conductors laminated one atop another; and a rotor integrally fixed to the shaft and having a turntable arranged in a top portion thereof for seating a disk and a magnet arranged in an underside portion thereof for cooperating with the armature to generate electromagnetic force to turn the rotor.

It is preferred that the main body comprises a mobile phone which includes a transmitting unit, a receiving unit and a keypad.

It is also preferred that the main body comprises a personal digital assistant which is compatible with computers to communicate information with the same.

It is preferred that the main body comprises a mobile computer.

It is preferred that the disk drive comprises a hard disk drive for storing information via magnetic recording.

It is preferred that the disk drive comprises an optical disk drive for storing information in an optical disk via optical signals.

It is also preferred that the disk drive is provided separate from the main body to be detachably mounted inside the main body, and further includes an interface unit for allowing the disk drive to share data with the main body.

According to still another aspect of the invention for realizing the object, there is provided a personal mobile communication system comprising: a main body having a data input unit, a main body circuit board and a liquid crystal display; and a disk drive having a spindle motor mounted inside the main body for rotating a data storage disk, wherein the spindle motor includes: a spindle motor circuit board selectively connected with the main body circuit board; a cylindrical housing fixedly mounted on the spindle body circuit board; a shaft rotatably inserted into the housing; a plurality of grooves formed in an inner periphery of the housing; a molybdenum disulfide film formed through penetration in the inner periphery of the housing including the grooves, the molybdenum disulfide film and the grooves serving as lubricant to the shaft during rotation of the shaft; an armature arranged on the circuit board adjacent to an outer periphery of the housing and having lamellar conductors laminated one atop another; and a rotor integrally fixed to the shaft and having a turntable arranged in a top portion thereof for seating a disk and a magnet arranged in an underside portion thereof for cooperating with the armature to generate electromagnetic force to turn the rotor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically illustrates a conventional personal mobile communication system;

FIG. 2 is a sectional view of a conventional spindle motor in use for a disk drive;

FIG. 3 is a sectional view of a spindle motor of the invention;

FIG. 4 is an exploded perspective view of the spindle motor shown in FIG. 3;

FIG. 5 is a sectional view illustrating a section of the spindle motor shown in FIG. 3 on which a film is formed;

FIG. 6 is a perspective view illustrating an embodiment of a personal mobile communication system incorporating the spindle motor shown in FIG. 3;

FIG. 7 is a side sectional view of the disk drive shown in FIG. 6; and

FIG. 8 is a side sectional view of an alternative to the disk drive shown in FIG. 6.

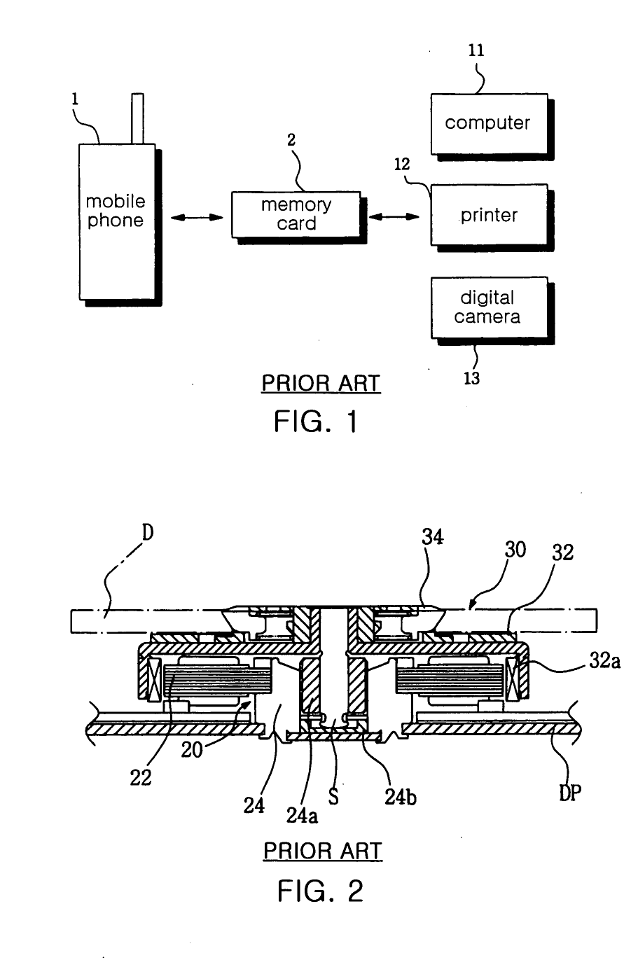

### DETAILED DESCRIPTION OF THE PREFERRED EMBODIMENT

The following detailed description will present preferred embodiments of the present invention with reference to the accompanying drawings.

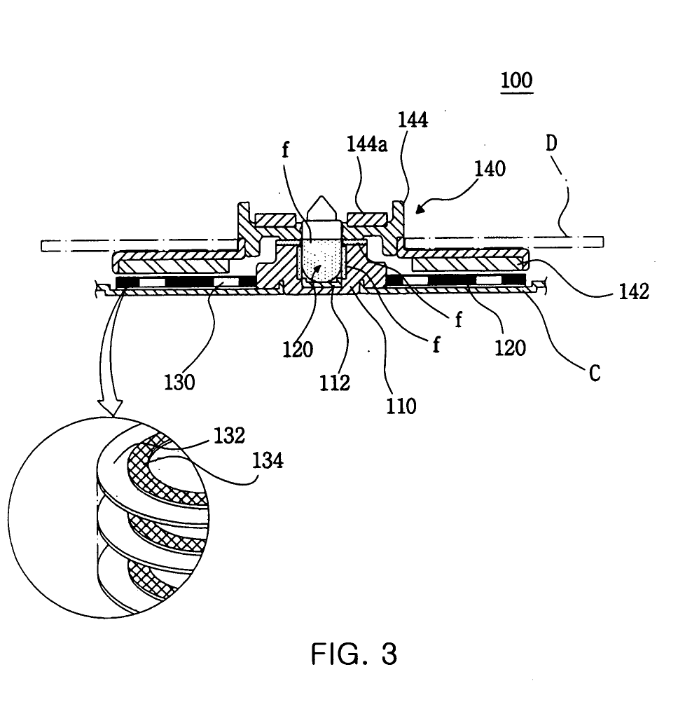

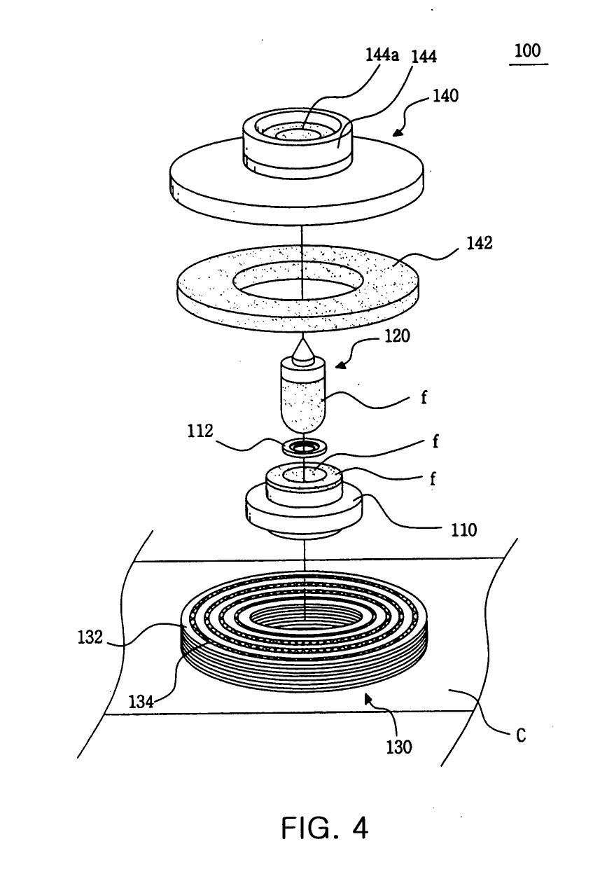

FIG. 3 is a sectional view of a spindle motor of the present invention, and FIG. 4 is an exploded perspective view of the spindle motor shown in FIG. 3.

As shown in FIGS. 3 and 4, a spindle motor 100 of the invention comprises a circuit board C, a cylindrical housing 110 mounted on the circuit board C and an armature 130 arranged around the housing 110 overlying the circuit board C for generating electromagnetic force.

The armature 130 has a plurality of laminated insulating plates 132 made of synthetic resin and copper coils 134 each patterned on each of the insulating plates 132 in the form of a circuit pattern of the circuit board C.

Alternatively, instead of patterning the coils 134 on the insulating plates 132, the armature 130 can be formed by attaching belt-shaped thin angled coils of a quadrangular cross section to the insulating plates 132.

In the present invention, the armature 130 is realized in the form of a thin film and thus has a very small height since the coils 134 are patterned on or attached to the insulating plates 132.

The spindle motor 100 of the present invention further comprises a shaft 120 which is inserted rotatably into the housing 110.

A thrust bearing 112 is arranged on a bottom portion of the housing 100 to reduce friction during rotation of the shaft 120. In the inner periphery of the housing 100 and the outer periphery of the shaft 120, there are selectively formed minute grooves and molybdenum disulfide films f having excellent lubricating ability.

The grooves are formed on the housing 100 and the shaft 120 by spraying molybdenum disulfide fluid, i.e., a material same as that of the films f under high pressure. Then, the molybdenum disulfide films f are formed on outside surfaces of the grooves.

The films f are formed in order to impart a function of solid bearing to the housing 100 and the shaft 120.

The housing 100 having the grooves and the film f formed in the inner periphery thereof functions as a solid bearing and the shaft 120 having the grooves and the film f formed in the outer periphery thereof also functions as a solid bearing.

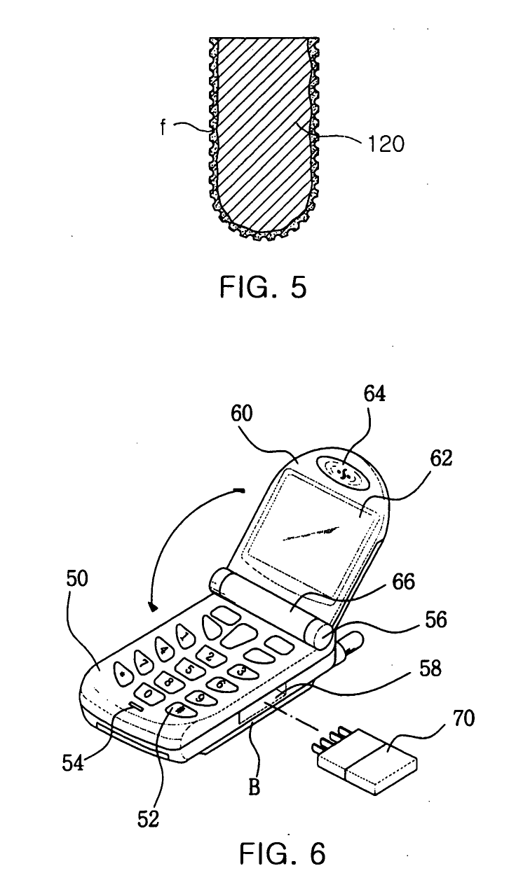

The films f can be formed selectively in the inner periphery of the housing 100 and the outer periphery of the shaft 120. The films f are also penetrated into the housing and shaft to a predetermined depth from the surfaces thereof. As a result, penetration of the film f can form a sectional configuration as shown in FIG. 5.

FIG. 5 illustrates the film f formed in the outer periphery of the shaft 120 via penetration. As a result, the film which reduces friction when the housing or the shaft having the film functions as the solid bearing can be formed relatively thicker and uniform on the surface of the shaft. This also provides an advantage in that the lifetime of the film can be prolonged.

The spindle motor 100 of the invention comprises a discal rotor 140 fixed to an upper portion of the shaft 120 at a predetermined gap from the armature 130.

A cylindrical seating section 144 is provided in the upper periphery of the rotor 140 to center a disk D, and an upper face of the rotor 140 functions as a turntable to secure the disk D which is centered by the seating section 144.

In an underside of the rotor 140, there is provided a layer of magnet 142 for cooperating with electromagnetic force of the armature 130 to turn the rotor 130. The magnet 142 is made of fine powder and formed in the underside of the rotor via printing or deposition.

Although printing causes the magnet to have a thick layer of binder for bonding magnet powder, this simplifies a process of forming magnet powder into the magnet layer to raise productivity. On the other hand, although a relatively long time period is required to deposit fine powder and thus has a low productivity, deposition does not use binder to increase the density of the magnet thereby improving magnetic characteristics.

As a result, the magnet 142 is provided in the form of a thin film to minimize the thickness thereof and thus the thickness of the rotor 140.

In the circumstances, the minimized thickness of the magnet 142 reduces the flux density of the magnet 142 to weaken the magnetic force of the same. In order to enhance the magnetic force of the magnet 142 in spite of the reduced thickness of the magnet 142, it is necessary to print or deposit magnet powder as much as possible on the underside of the rotor 140. Then, it is preferred that magnet powder has a particle size ranging about 500 to 1000 nm.

In order to minimize the entire height of the spindle motor 100, a lower central portion of the rotor 140 can be closely contacted with a top portion of the housing 110 as shown in FIG. 3. This structure requires small grooves formed in the top portion of the housing 110 and a molybdenum disulfide film f coated on the small grooves so as to impart a function of solid bearing to the top portion of the housing 110.

The reference numeral 144a indicates a pulling magnet which generates attractive force between the rotor 140 and the housing 110 so that the rotor 140 is not floated during high speed rotation.

In the spindle motor 100 of the above structure, when the disk D is seated on the rotor 140, a current applied from the circuit board C magnetizes the armature 130 generating electromagnetic force so that the magnet 142 of the rotor 140 interacts with the electromagnetic force of the armature 130 to turn the rotor 140 at a high speed.

Then, the disk D seated on the rotor 140 is also rotated at a high speed so that a pickup (not shown) can write or read data in/from the disk at a high rate.

As described above, the armature 130 and the magnet 142 are provided in the form of thin films and both the shaft 120 and the housing 110 serve as solid bearings owing to the molybdenum disulfide films f formed thereon so as to miniaturize the spindle motor of the invention.

The spindle motor 100 can be applied to a disk drive for use with a personal mobile communication system. FIG. 6 is a perspective view illustrating an embodiment of such a personal mobile communication system incorporating the spindle motor shown in FIG. 3.

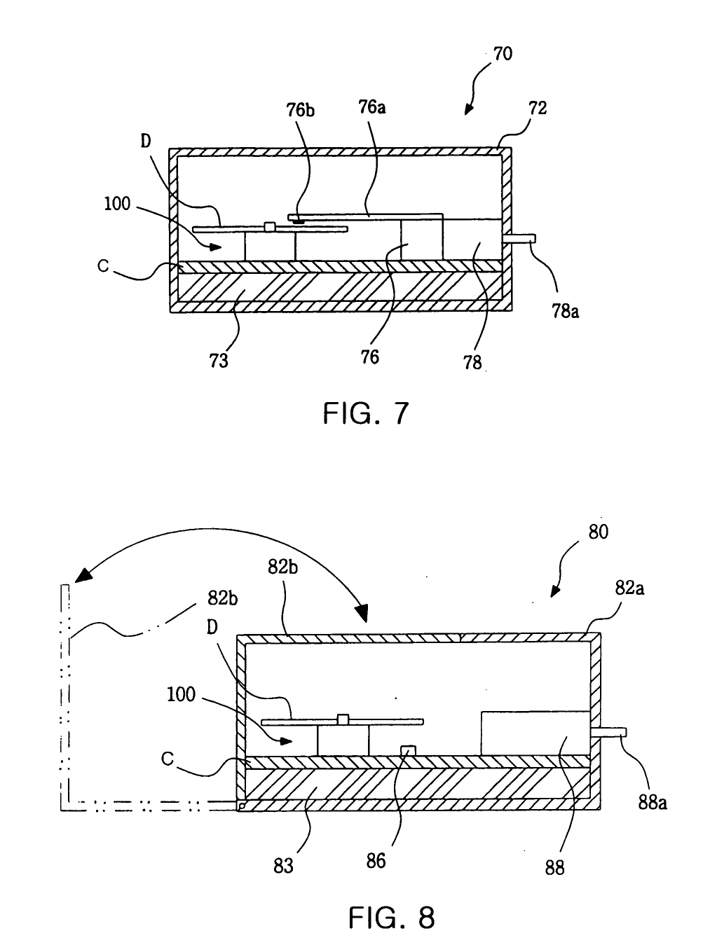

FIG. 7 is a sectional view illustrating a structure of the disk drive shown in FIG. 6, and FIG. 8 is a sectional view illustrating a structure of an alternative to the disk drive shown in FIG. 6.

Prior to explanation, it is to be understood that FIG. 6 illustrates a typical mobile phone as an example of the personal mobile communication system to which a disk drive 70 having the spindle motor 100 of the invention is applied.

As shown in FIGS. 6 and 7, the mobile phone comprises a main body 50 including a microphone 54 for audio input, a key pad 52 for data input and a battery B and a sub-body 60 including a speaker 64 for audio output and a liquid crystal display 62. The sub-body 60 has a hinge 56 which is integrally coupled with fixing sections 56 of the main body 50.

There is provided a chamber 58 in a middle portion of the main body 50 so that the disk drive 70 is inserted into the chamber 58 and integrally installed therein.

Describing the disk drive 70 with reference to FIG. 7, the disk drive 70 is a hard disk drive for storing and reading data via magnetic recording. The disk drive 70 includes a housing 72, a circuit board C arranged in a lower portion of the housing 72 and a spindle motor 100 of the invention arranged on the circuit board C.

A magnetic recording disk D made of metal is fixedly mounted on a top portion of the spindle motor 100. Adjacent to the spindle motor 100, there is installed a pickup 76 which includes a slider 76a with a magnetic head 76b for recording and extracting data in/from the disk D.

On an edge portion of the circuit board C, there is provided an interface unit 78 having pins projected out of the housing 72 to be grounded with the main body 50 so that the main body 50 can share data with the disk drive 70.

On the underside of the circuit board C, there is mounted a shock-absorbing member 73 which is made of elastic material to relieve the disk drive 70 from external impact applied thereto.

The disk drive 70 is provided separate from the main body 50 of the mobile phone and thus detachable from the same as shown in FIG. 6. When the disk drive 70 is loaded into the main body 50, the main body 50 controls the slider 76a and the magnetic head 76b of the pickup 76 via the interface unit 78 to write or read data in/from the disk D.

Of course, in the case of writing the data in the disk D, the data is inputted with the key pad 52 provided in the main body 50. In the case of replaying the data, images are played by the liquid crystal display 62 and audios are outputted by the speaker 64.

The data is inputted and outputted via the interface unit 78 which is electrically connected with the main body 50 through the pins 78a.

Alternatively, the invention can replace the disk drive 70 as shown in FIG. 7 with an optical disk drive 80 as shown in FIG. 8. The optical disk drive 80 comprises a stationary housing 82a, an openable housing 82b and a circuit board C equipped inside the stationary housing 82a.

The optical disk drive 80 also comprises a spindle motor 100 of the invention, which is mounted on the circuit board C, and an optical pickup 86 for writing and reading data in/from an optical disk D seated on the spindle motor 100.

Also, the optical disk drive 80 comprises pins 88a grounded with the main body 50 of the mobile phone and an interface unit 88 for communicating data with the main body 50.

In the optical disk drive 80 of the above structure, the openable housing 82b is opened to replace the optical disk D, and the optical pickup is used to write and read the data in/from the optical disk D.

Of course, the optical disk drive 80 is detachably loaded into the main body 50 via the chamber 58 formed in the main body 50, and the main body 50 communicates the data with the optical disk drive 80 via the interface unit 88.

At this time, the optical pickup 86 writes and reads the communicated data in/from the optical disk D.

Alternatively, any of the disk drives 70 and 80 can be mounted inside the main body 50 of the mobile phone by internally incorporating components of the disk drive 70 or 80 into a circuit board (not shown) of the main body 50.

Describing this in more detail, the components of the disk drive 70 or 80, i.e., the spindle motor 100, the pickup 76 or the optical pickup 86 and the circuit board C including the interface unit 78 or 88 are mounted on an upper or lateral portion of the circuit board of the main body 50.

Then, the disk drive 70 or 80 is integrally incorporated into the main body 50.

Of course, this structure can exclude the housing 72 or the housings 82a and 82b and the shock-absorbing member 73 or 83 of the disk drive 70 or 80.

Although the invention has been described with reference to the disk drive 70 or 80 applied to the mobile phone as an instance, the disk drive 70 or 80 can be applied not only to the mobile phone but also to a PDA or a notebook computer. Accordingly, the disk drive 70 or 80 can remarkably enlarge the data storage capacity of the personal mobile communication system at a small cost.

As the disk drive 70 or 80 is applied to the personal mobile communication system, a user can carry miniature disks D and play any of the disks D whenever he/she wants to write or replay various contents such as musics, movies, study materials and documents.

According to the invention, the hard disk or the optical disk which has excellent performance and cheap price can be used in the personal mobile communication system to enhance the availability of the personal mobile communication system as well as promote the economic advantage and convenience thereof.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

According to the spindle motor and the personal mobile communication system of the invention having the constructions and the operations as set forth above, the spindle motor can be miniaturized to reduce the size of the disk drive so that the disk drive can be applied to the personal mobile communication system in order to expand the data storage capacity of the mobile communication system by a large quantity over conventional mobile communication systems which use expensive memory cards.

Furthermore, the invention allows a user of the mobile communication system to utilize various data thereby raising the availability of the mobile communication system as well as promoting the convenience thereof.

What is claimed is:

1. A spindle motor for disk drives comprising:
a circuit board;
a cylindrical housing fixedly mounted on the circuit board and allowing a shaft to be rotatably inserted into the housing;
a plurality of grooves formed in an inner periphery of the housing;
a molybdenum disulfide film formed through penetration in the inner periphery of the housing including the grooves, the molybdenum disulfide film and the grooves serving as lubricant to the shaft during rotation of the shaft;
an armature arranged on the circuit board adjacent to an outer periphery of the housing and having lamellar conductors laminated one atop another; and
a rotor integrally fixed to the shaft and having a turntable arranged in a top portion thereof for seating a disk and a magnet arranged in an underside portion thereof for cooperating with the armature to generate electromagnetic force to turn the rotor.

2. The spindle motor for disk drives as set forth in claim 1, wherein the grooves are formed radially in the inner periphery of the housing at a uniform spacing in an axial direction.

3. The spindle motor for disk drives as set forth in claim 1, wherein the grooves are formed in the inner periphery of the housing by spraying fluid under high pressure, the fluid being made of a material same as that of the molybdenum disulfide film.

4. The spindle motor for disk drives as set forth in claim 1, wherein the magnet of the rotor is formed by printing magnet powder on the underside portion of the rotor.

5. The spindle motor for disk drives as set forth in claim 4, wherein the magnetic powder has a particle size ranging about 500 to 1000 nm so that a large number of powder particles cohere at the underside portion of the rotor to enhance magnetic force.

6. The spindle motor for disk drives as set forth in claim 1, wherein the magnet of the rotor is formed by depositing magnetic powder on the underside portion of the rotor.

7. The spindle motor for disk drives as set forth in claim 6, wherein the magnetic powder has a particle size ranging about 500 to 1000 nm so that a large number of powder particles cohere at the underside portion of the rotor to enhance magnetic force.

8. A spindle motor for disk drives comprising:
a circuit board;
a cylindrical housing fixedly mounted on the circuit board;
a shaft rotatably inserted into the housing;
a plurality of grooves formed in an inner periphery of the housing;
a molybdenum disulfide film formed through penetration in the inner periphery of the housing including the grooves, the molybdenum disulfide film and the grooves serving as lubricant to the shaft during rotation of the shaft;
an armature arranged on the circuit board adjacent to an outer periphery of the housing and having lamellar conductors laminated one atop another; and
a rotor integrally fixed to the shaft and having a turntable arranged in a top portion thereof for seating a disk and a magnet arranged in an underside portion thereof for cooperating with the armature to generate electromagnetic force to turn the rotor.

9. The spindle motor for disk drives as set forth in claim 8, wherein the grooves are formed in the inner periphery of the housing by spraying fluid under high pressure, the fluid being made of a material same as that of the molybdenum disulfide film.

10. The spindle motor for disk drives as set forth in claim 8, wherein the magnet of the rotor is formed by printing magnet powder on the underside portion of the rotor.

11. The spindle motor for disk drives as set forth in claim 10, wherein the magnetic powder has a particle size ranging about 500 to 1000 nm so that a large number of powder particles cohere at the underside portion of the rotor to enhance magnetic force.

12. The spindle motor for disk drives as set forth in claim 8, wherein the magnet of the rotor is formed by depositing magnetic powder on the underside portion of the rotor.

13. The spindle motor for disk drives as set forth in claim 12, wherein the magnetic powder has a particle size ranging about 500 to 1000 nm so that a large number of powder particles cohere at the underside portion of the rotor to enhance magnetic force.

14. A personal mobile communication system comprising:
a main body having a data input unit, a main body circuit board and a liquid crystal display; and
a disk drive having a spindle motor mounted inside the main body for rotating a data storage disk, wherein the spindle motor includes:
a spindle motor circuit board selectively connected with the main body circuit board;
a cylindrical housing fixedly mounted on the spindle motor circuit board and allowing a shaft to be rotatably inserted into the housing;
a plurality of grooves formed in an inner periphery of the housing;
a molybdenum disulfide film formed through penetration in the inner periphery of the housing including the grooves, the molybdenum disulfide film and the grooves serving as lubricant to the shaft during rotation of the shaft;
an armature arranged on the spindle motor circuit board adjacent to an outer periphery of the housing and having lamellar conductors laminated one atop another; and
a rotor integrally fixed to the shaft and having a turntable arranged in a top portion thereof for seating a disk and a magnet arranged in an underside portion thereof for cooperating with the armature to generate electromagnetic force to turn the rotor.

15. The personal mobile communication system as set forth in claim 14, wherein the main body comprises a mobile phone which includes a transmitting unit, a receiving unit and a key pad.

16. The personal mobile communication system as set forth in claim 14, wherein the main body comprises a personal digital assistant which is compatible with computers to communicate information with the same.

17. The personal mobile communication system as set forth in claim 14, wherein the main body comprises a mobile computer.

18. The personal mobile communication system as set forth in claim 14, wherein the disk drive comprises a hard disk drive for storing information via magnetic recording.

19. The personal mobile communication system as set forth in claim 14, wherein the disk drive comprises an optical disk drive for storing information in an optical disk via optical signals.

20. The personal mobile communication system as set forth in claim 14, wherein the disk drive is provided separate from the main body to be detachably mounted inside the main body, and further includes an interface unit for allowing the disk drive to share data with the main body.

21. The personal mobile communication system as set forth in claim 14, wherein the grooves are formed in the inner periphery of the housing by spraying fluid under high pressure, the fluid being made of a material same as that of the molybdenum disulfide film.

22. The personal mobile communication system as set forth in claim 14, wherein the magnet of the rotor is formed by printing magnet powder on the underside portion of the rotor.

23. The personal mobile communication system as set forth in claim 14, wherein the magnetic powder has a particle size ranging about 500 to 1000 nm so that a large number of powder particles cohere at the underside portion of the rotor to enhance magnetic force.

24. The personal mobile communication system as set forth in claim 14, wherein the magnet of the rotor is formed by depositing magnetic powder on the underside portion of the rotor.

25. The personal mobile communication system as set forth in claim 24, wherein the magnetic powder has a particle size ranging about 500 to 1000 nm so that a large number of powder particles cohere at the underside portion of the rotor to enhance magnetic force.

26. A personal mobile communication system comprising:
a main body having a data input unit, a main body circuit board and a liquid crystal display; and
a disk drive having a spindle motor mounted inside the main body for rotating a data storage disk, wherein the spindle motor includes:
a spindle motor circuit board selectively connected with the main body circuit board;
a cylindrical housing fixedly mounted on the spindle body circuit board;
a shaft rotatably inserted into the housing;
a plurality of grooves formed in an inner periphery of the housing;
a molybdenum disulfide film formed through penetration in the inner periphery of the housing including the grooves, the molybdenum disulfide film and the grooves serving as lubricant to the shaft during rotation of the shaft;
an armature arranged on the circuit board adjacent to an outer periphery of the housing and having lamellar conductors laminated one atop another; and
a rotor integrally fixed to the shaft and having a turntable arranged in a top portion thereof for seating a disk and a magnet arranged in an underside portion thereof for cooperating with the armature to generate electromagnetic force to turn the rotor.

27. The personal mobile communication system as set forth in claim 26, wherein the main body comprises a mobile phone which includes a transmitting unit, a receiving unit and a key pad.

28. The personal mobile communication system as set forth in claim 26, wherein the main body comprises a personal digital assistant which is compatible with computers to communicate information with the same.

29. The personal mobile communication system as set forth in claim 26, wherein the main body comprises a mobile computer.

30. The personal mobile communication system as set forth in claim 26, wherein the disk drive comprises a hard disk drive for storing information via magnetic recording.

31. The personal mobile communication system as set forth in claim 26, wherein the disk drive comprises an optical disk drive for storing information in an optical disk via optical signals.

32. The personal mobile communication system as set forth in claim 26, wherein the disk drive is provided separate from the main body to be detachably mounted inside the main body, and further includes an interface unit for allowing the disk drive to share data with the main body.

33. The personal mobile communication system as set forth in claim 26, wherein the grooves are formed in the inner periphery of the housing by spraying fluid under high pressure, the fluid being made of a material same as that of the molybdenum disulfide film.

34. The personal mobile communication system as set forth in claim 26, wherein the magnet of the rotoris formed by printing magnet powder in the underside portion of the rotor.

35. The personal mobile communication system as set forth in claim 34, wherein the magnetic powder has a particle size ranging about 500 to 1000 nm so that a large number of powder particles cohere at the underside portion of the rotor to enhance magnetic force.

36. The personal mobile communication system as set forth in claim 26, wherein the magnet of the rotor is formed by depositing magnetic powder on the underside portion of the rotor.

37. The personal mobile communication system as set forth in claim 36, wherein the magnetic powder has a particle size ranging about 500 to 1000 nm so that a large number of powder particles cohere at the underside portion of the rotor to enhance magnetic force.
